(19) United States
(12) Patent Application Publication
(10) Pub. No.: US 2007/0028843 A1
(43) Pub. Date: Feb. 8, 2007

(54) Bird feeder accessory

(75) Inventor: Robert Kenneth Nock, Mellieha (MT)

Correspondence Address: BUCHANAN, INGERSOLL & ROONEY PC, POST OFFICE BOX 1404, ALEXANDRIA, VA, 22313-1404, US

(73) Assignee: C J Wildbird Foods Limited, Shrewsbury (GB)

(21) Appl. No.: 11/494,579

(22) Filed: Jul. 28, 2006

(30) Foreign Application Priority Data
Jul. 28, 2005 (GB) 0515493.5

(51) Int. Cl. A01K 39/01

(52) U.S. Cl. 119/51.03

(57) ABSTRACT

A wire cage birdfeeder including a first cage member and a second cage member; the first and second cage members being pivotally connected such that when the feeder is in a closed position the first and second cage members are substantially flush with one another so forming a closed cage; and when in an open position the cage members are partly separated so presenting a filling mouth and further including a closer/hanger that when in a first position allows the first and second cage members to pivot open to present a mouth for charging and when in a closed position prevent such opening.

### BACKGROUND OF THE INVENTION

The present invention relates to a bird feeder and in particular a feeder for use with blocks of food.

Frames and cages are known for use with birdfood in block form; for example suet block feeders. An aim of the present invention is to provide an improved birdfeeder cage of this type.

### SUMMARY OF THE INVENTION

In a first aspect, the invention comprises a cage birdfeeder having a first cage member and a second cage member; the first and second cage members being pivotally connected such that when the feeder is in a closed position the first and second cage members are substantially flush with one another so forming a closed cage; and when in an open position the cage members are partly separated so presenting a filling mouth; further comprising a closer/hanger having a pair of generally linear elongate arms that are mutually parallel and are connected at a first end, by an intermediate portion, to each other.

Preferably, the first and/or second cage member is non-planar in shape. The first and second cage members may be substantially rectangular in at least one plane. Preferably, the first and second cage members are the same shape. More preferably, the first and second cage members are identical. This reduces production cost.

One or both of the cage members may have a hinge loop configured to pivotally engage the other cage member. Preferably, each cage member has an identical hinge loop. Preferably at least part of the birdfeeder is made of wire. Preferably, the cage member presents a wire grid the grid spacing being in the range 10 to 30 mm and more preferably 15 to 25 mm.

Preferably, the first and second cage members each have a rim where in use the intermediate portion engages the rim of both cage members; thereby to keep the birdfeeder in a closed position. More preferably, when in a first position the closer hanger allows the first and second cage members to pivot open to present a mouth for charging and when in a closed position prevent such opening.

### BRIEF DESCRIPTION OF THE DRAWING FIGURES

An embodiment of the invention will now be described by reference to the following diagrammatic illustrations in which:

FIG. 1 shows a front/back views of a feeder according to the invention;

FIG. 2 shows a side view of the feeder of FIG. 1 in the closed and hanging position;

FIG. 3 shows a side view of the feeder of FIG. 1 in the open position for filing:

FIG. 4 shows a perspective view of the hanger portion of the feeder of FIG. 1; and

FIG. 5 shows a perspective view of one of the pair of wire cages for the feeder of FIG. 1.

### DETAILED DESCRIPTION OF THE INVENTION

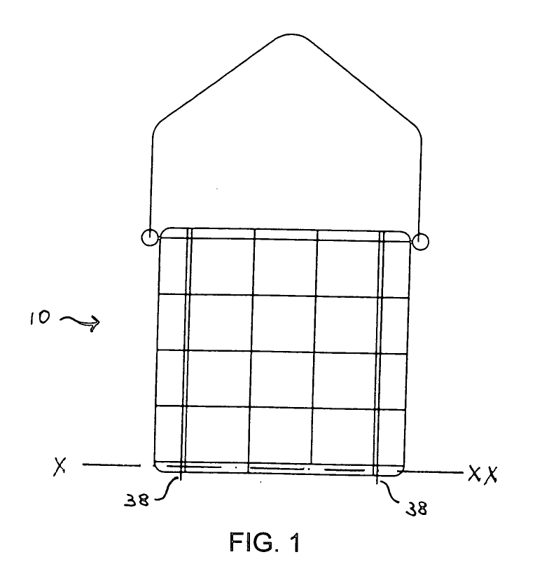

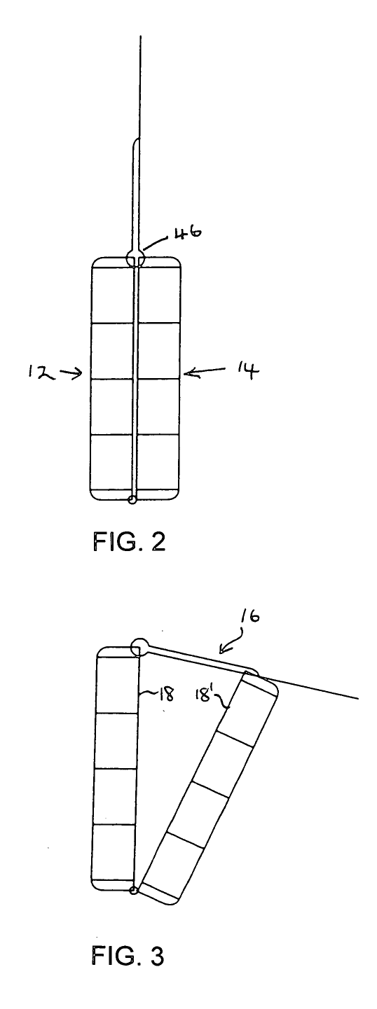

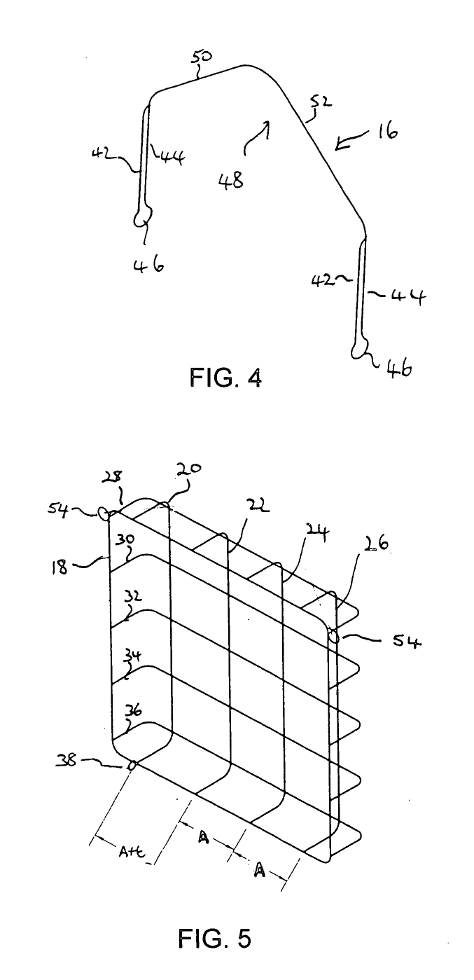

A first embodiment of a birdfeeder food block cage according to the invention is illustrated in FIGS. 1 to 5. The birdfeeder 10 comprises front and rear cage members 12, 14 (see FIGS. 2 and 3) and a hanger 16 (see FIG. 4) that also serves as a latch. Cage members 12 and 14 are preferably identical and pivot relative to each other about a pivot axis X-XX (see FIG. 1).

FIG. 5 shows a perspective view of the cage member 12,14. Cage member 12,14 comprises rims 18 and 18′ respectively that are generally rectangular in shape and made of wire. Attached to the upper and lower portions of each rim 18 are four U-shaped elements 20, 22, 24 and 26 and attached to the side portions of rim 18 are five U-shaped elements 28, 30, 32, 34 and 36. These elements are located at right angles to elements 20, 22, 24 and 26 to form a grid; the distance between adjacent grid elements is generally 10 to 30 mm and preferably about 25 mm. While the grid illustrated in the figures has substantially square apertures these apertures may also be rectangular. The distance between outer horizontal grid element 20 and adjacent vertical grid element 22 is slightly greater; thus if the normal grid spacing is A mm the spacing between elements 20 and 22 is (A+t) mm; where t (mm) is the thickness of the wire used to form the grid (see FIG. 5). A hinge loop 38 is located on the lower portion of rim 18 adjacent the joint between rim 18 and vertical grid element 20. Before assembly hinge loop 38 may take the form of a split ring or the like. During assembly of two identical cage members to form a hinged pair; the lower rim portion of one of the cage member pairs is passed through the split in the hinge loop 38 of the other cage member and the loops 38 are located outermost (see FIG. 1). In this way the two cage members are hinged together so that cage member 14 may pivot relative to cage member 12, and advantageously, little or no axial movement of one cage member relative to the other being possible; axial movement being defined as movement in the direction of pivot axis X-XX (see FIG. 1).

The block feed cage further comprises a hanger 16 having a pair of linear elongate parallel wire portions 42,44; each pair being connected at a first end by an arcuate portion 46. Each elongate pair 42, 44 is held spaced apart in parallel relationship by intermediate hanger portion 48 comprising two generally linear wire arms 50, 52 extending in generally orthogonal directions and connected at the distal ends to wire portions 44. Prior to assembly the second end of wire portions 42 are unattached. During assembly, the second end of wire portions 42 are threaded through the eyes of wire loops 54; loops 54 being attached to rims 18 near their upper two corners. Finally, after connecting loop portions 38 of each cage member 12, 14 (see above); the (free) second ends of wire portions 42 are attached to the second ends of wire portions 44. This results in two cage members 12, 14 that are hinged so that they may pivot about axis X-XX; the degree of pivotal motion being limited by hanger 16 (see FIG. 3). In the (open) position illustrated in FIG. 3 a food block (not shown) may be inserted between cage members 12 and 14. The cage members may then be pushed together (see FIG. 2) and the hanger 16 moved from the approximately horizontal position shown in FIG. 3 to the vertical position shown in FIG. 2. In this vertical position the arcuate portion 46 of hanger 16 ensures that the cage members 12 and 14 remain closed as shown in FIG. 2. In this position the wire cage birdfeeder may also be hung in a generally vertical plane by attaching hanger portion 48 to a tree branch or the like.

What is claimed is:

1. A cage birdfeeder comprising a first cage member and a second cage member; the first and second cage members being pivotally connected such that when the feeder is in a closed position the first and second cage members are substantially flush with one another so forming a closed cage; and when in an open position the cage members are partly separated so presenting a filling mouth; further comprising a closer/hanger having a pair of generally linear elongate arms that are mutually parallel and are connected at a first end, by an intermediate portion, to each other.

2. A birdfeeder according to claim 1 wherein the first and/or second cage member is non-planar in shape.

3. A birdfeeder according to claim 1 wherein the first and second cage members are substantially rectangular in at least one plane.

4. A birdfeeder according to claim 1 wherein the first and second cage members are the same shape.

5. A birdfeeder according to claim 4 wherein the first and second cage members are identical.

6. A birdfeeder according to claim 1 wherein each cage member has a hinge loop configured to pivotally engage the other cage member.

7. A birdfeeder according to claim 1 made at least partly of wire.

8. A birdfeeder according to claim 1 wherein a cage member presents a wire grid, the grid spacing being in the range 10 to 30 mm.

9. A birdfeeder according to claim 1 wherein the first and second cage members each have a rim and where, in use, the intermediate portion engages the rim of both cage members; thereby to keep the birdfeeder in a closed position

10. A birdfeeder according to claim 1 wherein when in a first position the closer hanger allows the first and second cage members to pivot open to present the mouth for charging and when in a closed position prevent such opening.
